(19) United States
(12) Patent Application Publication
(10) Pub. No.: US 2019/0196695 A1
(43) Pub. Date: Jun. 27, 2019

(54) DOCUMENT PROCESSING APPARATUS AND NON-TRANSITORY COMPUTER READABLE MEDIUM STORING PROGRAM

(71) Applicant: FUJI XEROX CO., LTD., TOKYO (JP)

(72) Inventors: Shingo KATO, Kanagawa (JP); Masayuki IWASAWA, Kanagawa (JP); Yoshie OHIRA, Kanagawa (JP)

(73) Assignee: FUJI XEROX CO., LTD., TOKYO (JP)

(21) Appl. No.: 16/212,807

(22) Filed: Dec. 7, 2018

(30) Foreign Application Priority Data
Dec. 21, 2017 (JP) 2017-245069

(51) Int. Cl. G06F 3/0484; G06F 3/0481; G06F 17/21

(52) U.S. Cl. CPC G06F 3/04842; G06F 3/0481; G06F 17/24; G06F 3/04812; G06F 17/212

(57) ABSTRACT

A document processing apparatus includes an execution unit that executes text selection processing for selecting text data from an electronic document, and a display controller that performs, when the text data is not included in the electronic document, control so as to display an indication that execution of the text selection processing is disabled before a user attempts to execute the text selection processing.

### CROSS-REFERENCE TO RELATED APPLICATIONS

This application is based on and claims priority under 35 USC 119 from Japanese Patent Application No. 2017-245069 filed Dec. 21, 2017.

### BACKGROUND

### Technical Field

The present invention relates to a document processing apparatus and a non-transitory computer readable medium storing a program.

### SUMMARY

According to an aspect of the invention, there is provided a document processing apparatus including an execution unit that executes text selection processing for selecting text data from an electronic document, and a display controller that performs, when the text data is not included in the electronic document, control so as to display an indication that execution of the text selection processing is disabled before a user attempts to execute the text selection processing.

### BRIEF DESCRIPTION OF THE DRAWINGS

An exemplary embodiment of the present invention will be described in detail based on the following figures, wherein:

FIG. 1 illustrates the configuration of a document management system of one exemplary embodiment of the present invention;

FIG. 2 is a block diagram illustrating the hardware configuration of a document processing apparatus in the exemplary embodiment of the present invention;

FIG. 3 is a block diagram illustrating the functional configuration of the document processing apparatus in the exemplary embodiment of the present invention;

FIG. 4 illustrates an example of a display screen of the document processing apparatus;

FIG. 5 illustrates an example of the display screen of the document processing apparatus when attribute information is added to document data;

FIG. 6 is a flowchart for illustrating an operation of the document processing apparatus;

FIG. 7A illustrates an example of the display screen of the document processing apparatus when text data is included in the document data;

FIG. 7B illustrates an example of the display screen of the document processing apparatus when the text data is not included in the document data;

FIG. 8A illustrates an example of the display screen of the document processing apparatus when the text data is included in the document data;

FIG. 8B illustrates an example of the display screen of the document processing apparatus when the text data is not included in the document data;

FIG. 9 illustrates an example of the display screen of the document processing apparatus for description of a timing to acquire text presence/absence information in a display page of the document data;

FIG. 10 illustrates an example of the display screen of the document processing apparatus when the text data is not included in the display page of the document data;

FIG. 11 illustrates an example of the display screen of the document processing apparatus when the text data is included in a partial area of the display page of the document data; and

FIG. 12 illustrates an example of the display screen of the document processing apparatus for description of the timing to acquire the text presence/absence information in the display page of the document data.

### DETAILED DESCRIPTION

An exemplary embodiment of the present invention is described in detail with reference to the drawings.

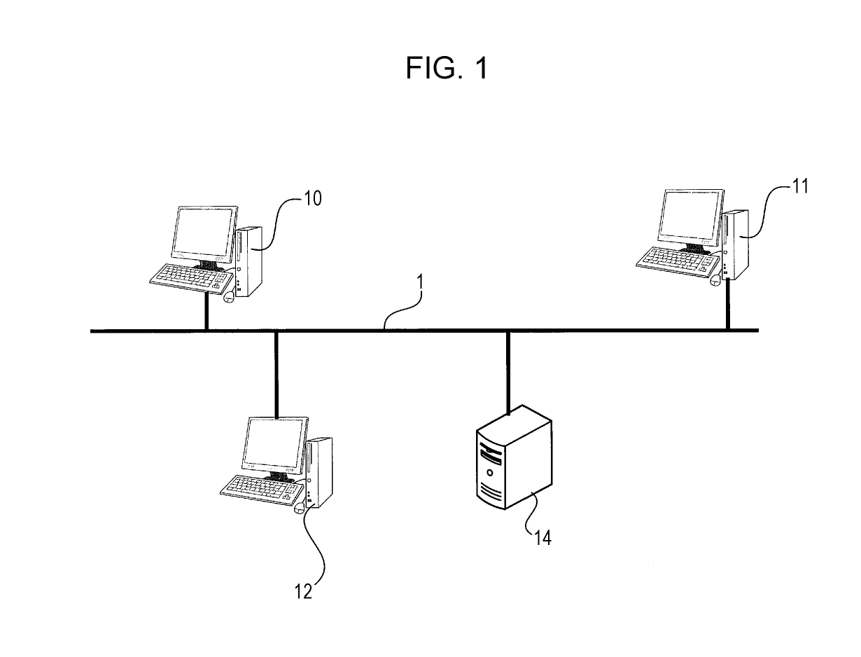

FIG. 1 illustrates the system configuration of a document management system of one exemplary embodiment of the present invention.

As illustrated in FIG. 1, the document management system of the exemplary embodiment of the present invention is configurated by document processing apparatuses 10 to 12 such as personal computers and a server apparatus 14 that are connected to each other via a network 1.

Document management software is installed in each of the document processing apparatuses 10 to 12. With the document management software, an attribute information adding program is executed to add attribute information to, for example, document data on an electronic document such as an application document or a scanned document. Thus, plural pieces of document data may be sorted.

In the document processing apparatuses 10 to 12, document data generated by adding the attribute information and a file that stores the document data may be transmitted, received, viewed, or revised.

The server apparatus 14 is connected to each of the document processing apparatuses 10 to 12 via the network 1 and is capable of storing the document data generated by adding the attribute information by each of the document processing apparatuses 10 to 12 and the file that stores the document data. Each of the document processing apparatuses 10 to 12 is capable of reading the document data that is generated by adding the attribute information and is stored in the server apparatus 14 and the file that stores the document data and is stored in the server apparatus 14. Thus, the document processing apparatuses 10 to 12 may exchange the document data and the file via the server apparatus 14.

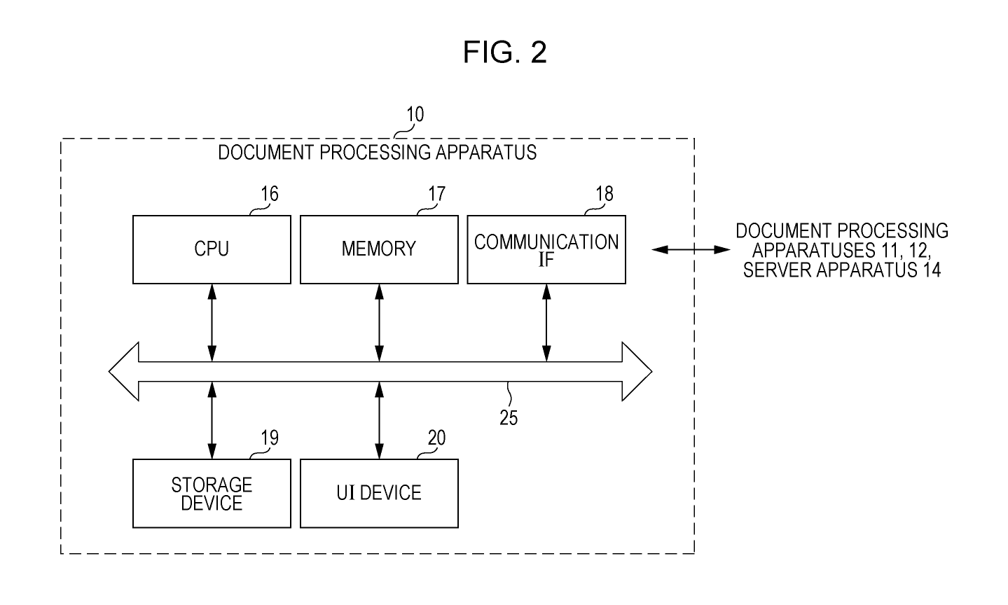

FIG. 2 illustrates the hardware configuration of the document processing apparatus 10 in the document management system of this exemplary embodiment. The configurations of the document processing apparatuses 11 and 12 are identical to the configuration of the document processing apparatus 10 and description thereof is therefore omitted.

As illustrated in FIG. 2, the document processing apparatus 10 includes a CPU 16, a memory 17, a communication interface (IF) 18 that transmits and receives data to and from external apparatuses and the like via the network 1, a storage device 19 such as a hard disk drive (HDD), and a user interface (UI) device 20 including a touch panel or a liquid crystal display and a keyboard. Those components are connected to each other via a control bus 25.

The CPU 16 controls an operation of the document processing apparatus 10 by executing predetermined processing based on the attribute information adding program stored in the memory 17 or the storage device 19. This exemplary embodiment is described under the assumption that the CPU 16 reads and executes the attribute information adding program stored in the memory 17 or the storage device 19. The program may be provided to the CPU 16 by being stored in a storage medium such as a CD-ROM.

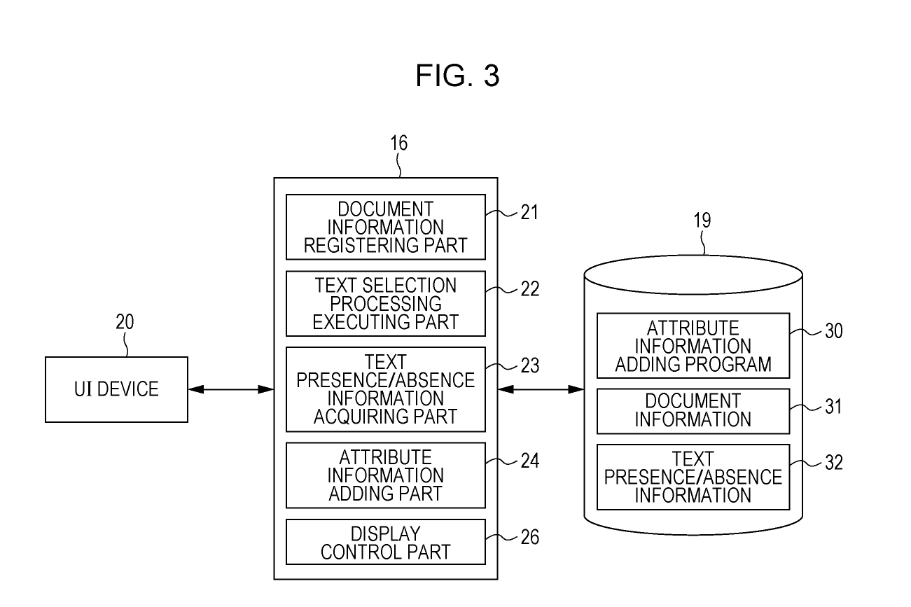

FIG. 3 is a block diagram illustrating the functional configuration of the document processing apparatus 10 that is implemented by executing the attribute information adding program described above.

The document processing apparatus 10 causes the CPU 16 serving as a control part to execute an attribute information adding program 30 stored in the storage device 19, thereby functioning as a document information registering part 21, a text selection processing executing part 22, a text presence/absence information acquiring part 23, an attribute information adding part 24, and a display control part 26.

The storage device 19 stores the attribute information adding program 30, document information 31, and text presence/absence information 32.

The attribute information adding program 30 is a program that causes the CPU 16 to operate as the document information registering part 21, the text selection processing executing part 22, the text presence/absence information acquiring part 23, the attribute information adding part 24, and the display control part 26.

The document information 31 is information such as text information related to text data, image information related to image data, and video information related to video data. The document information 31 includes document information having attribute information added by the attribute information adding part 24.

The text presence/absence information 32 is information that is related to the presence or absence of text data and is acquired from document data by the text presence/absence information acquiring part 23. The text presence/absence information 32 stores information related to the presence or absence of text data in each page of the document data. When attribute information that allows determination that the document data is data such as image data other than text data is added to the document data, the attribute information is also stored as the text presence/absence information 32.

The document information registering part 21 registers new document information as the document information 31 stored in the storage device 19 in response to a registration request.

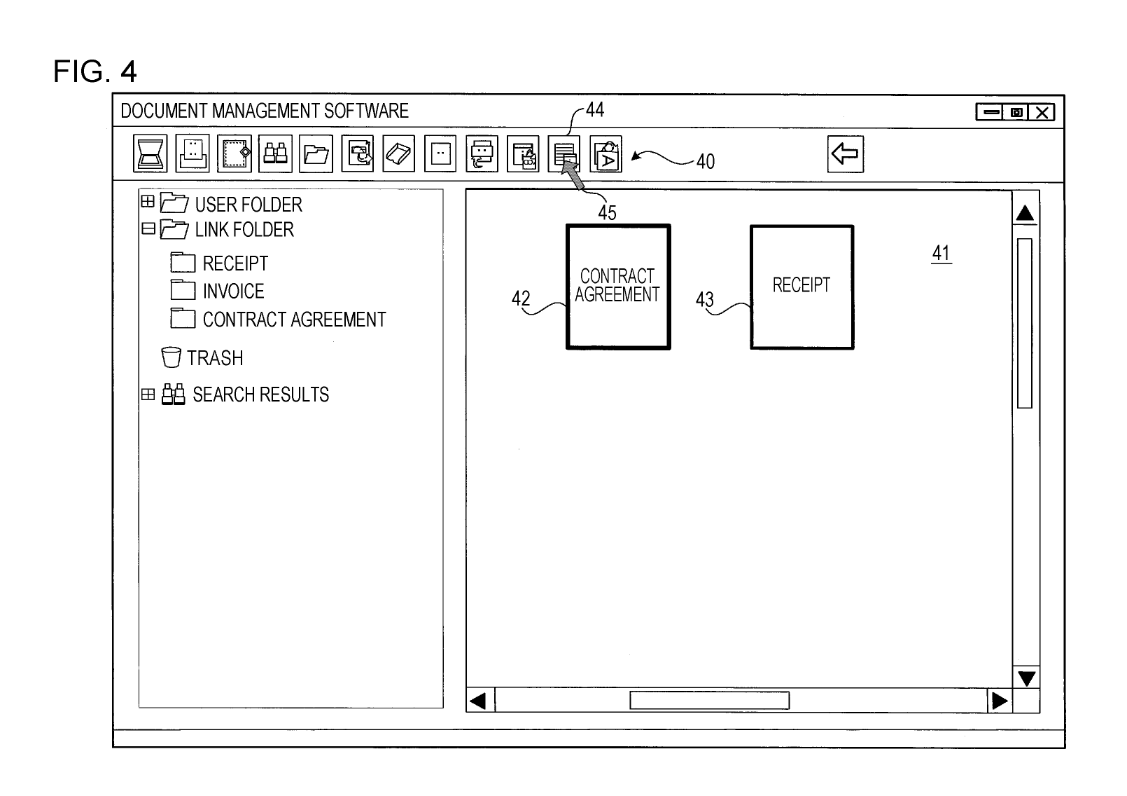

The text selection processing executing part 22 executes text selection processing for selecting the text data from the document data. The execution of the text selection processing herein refers to such an operation that a user moves a cursor to perform text selection (text selection mode). The cursor is a position specifying object to be used by the user for indicating a position on an operation screen of the UI device 20. An object such as an arrow-shaped cursor 45 described later as illustrated in FIG. 4 is used.

The text presence/absence information acquiring part 23 collectively acquires pieces of information on the presence or absence of the text data in all the pages of the document data.

The text presence/absence information acquiring part 23 acquires the text presence/absence information 32 in the display page from the storage device 19 when the document data is displayed. The text presence/absence information acquiring part 23 also acquires the text presence/absence information 32 in the display page from the storage device 19 when transition is made to a state in which the text selection processing is enabled. The text presence/absence information acquiring part 23 also acquires the text presence/absence information 32 in the display page from the storage device 19 every time the page is switched. The transition to the state in which the text selection processing is enabled herein refers to an operation to be performed before the text selection processing is executed. This operation is performed in order to make transition to the text selection mode as typified by an operation on an operation image for text selection. The operation image herein refers to an image provided in order to accept execution of the operation. The operation image only needs to be such an image that the user may specify the operation. Therefore, the operation image may be represented by a picture, illustration, or text.

The attribute information adding part 24 adds the attribute information to the document data in response to the registration request. The attribute information adding part 24 adds, to the document data as the attribute information, the information on the presence or absence of the text data that is acquired by the text presence/absence information acquiring part 23.

When the text data is not included in the document data, the display control part 26 performs control so as to display an indication that the execution of the text selection processing is disabled before the user attempts to execute the text selection processing by using the text selection processing executing part 22.

When the text data is not included in the document data, the display control part 26 performs control so as to display an indication that the user is not allowed to select the operation image for transition to the text selection processing by using the text selection processing executing part 22. Specifically, the operation image is, for example, grayed out (dimmed out).

When the text data is not included in the document data and when the cursor is moved onto the operation image for transition to the state in which the text selection processing is enabled, the display control part 26 performs the control so as to display the indication that the execution of the text selection processing is disabled.

When the text data is not included in the document data and when transition is made to the state in which the text selection processing is enabled, the display control part 26 performs control so as to display information indicating that the execution of the text selection processing is disabled while the information is superposed on a view image of the document data.

When the text data is included in a partial area of the document data and when transition is made to the state in which the text selection processing is enabled, the display control part 26 performs control so as to display, in a distinguishable manner, the area where the text data is included and the area where the text data is not included.

When the page of the document data to be displayed is switched and when the text data is not included in the page, the display control part 26 performs the control so as to display the indication that the execution of the text selection processing is disabled.

When the text presence/absence information 32 of each page is added to the document data as the attribute information, the display control part 26 performs control so as to display whether the text data is included in each page of the document data by referring to the text presence/absence information 32.

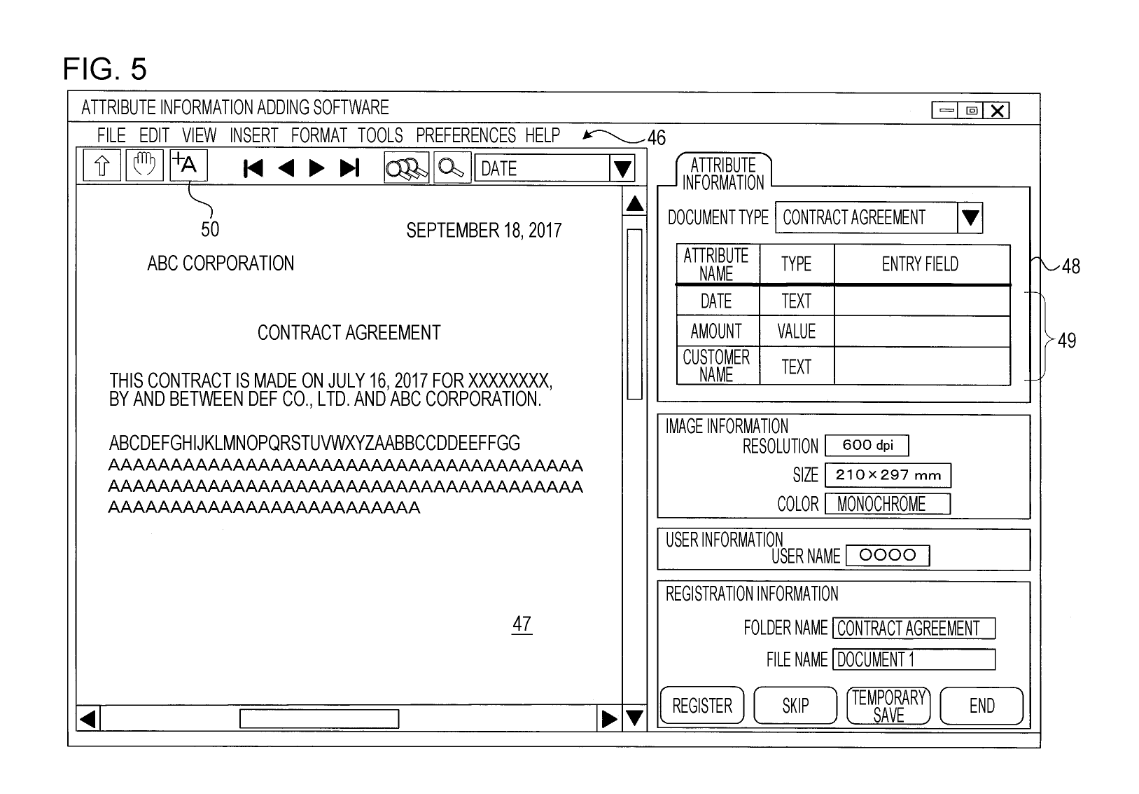

Next, an example of a display screen when the document management software is loaded to execute the attribute information adding program 30 is described in detail with reference to FIG. 4 and FIG. 5.

First, the document management software is activated and a display screen illustrated in, for example, FIG. 4 is displayed on the UI device 20.

Document data such as a contract agreement 42 and a receipt 43 is displayed in a workspace 41.

Various functions to be executed for the document data displayed in the workspace 41 are displayed on a tool bar 40 as tools.

The tool bar 40 is provided with an attribute information addition image 44 to be used for executing the attribute information adding program 30 for adding the attribute information to the document data.

That is, when, for example, the contract agreement 42 that is the document data displayed in the workspace 41 is selected and the attribute information addition image 44 on the tool bar 40 is clicked by moving the cursor 45 onto the attribute information addition image 44, the attribute information adding program 30 is activated and a screen for adding the attribute information to the contract agreement 42 that is the document data is displayed on the display screen as illustrated in FIG. 5.

Specifically, various functions to be executed for the document data are displayed on a tool bar 46 of the display screen as tools by activating the attribute information adding program. Further, a view screen 47 for the document data, a setting screen 48 for adding the attribute information, an entry field 49, and the like are displayed.

The tool bar 46 is provided with a text selection image 50 that is the operation image for transition to the text selection mode.

The application document to be used as the document data may include plural types of data such as text data, image data, and video data. The data is stored in the storage device 19. The scanned document to be used as the document data is stored in the storage device 19 as image data. That is, the text selection is disabled in the text selection mode for the data such as the image data and the video data other than the text data.

The document processing apparatus 10 is capable of recognizing whether the text data is included in the document data before the user actually performs the operation for the text selection. The document processing apparatus 10 is also capable of recognizing the area that is not selectable in the text selection mode before the user actually performs the operation for the text selection.

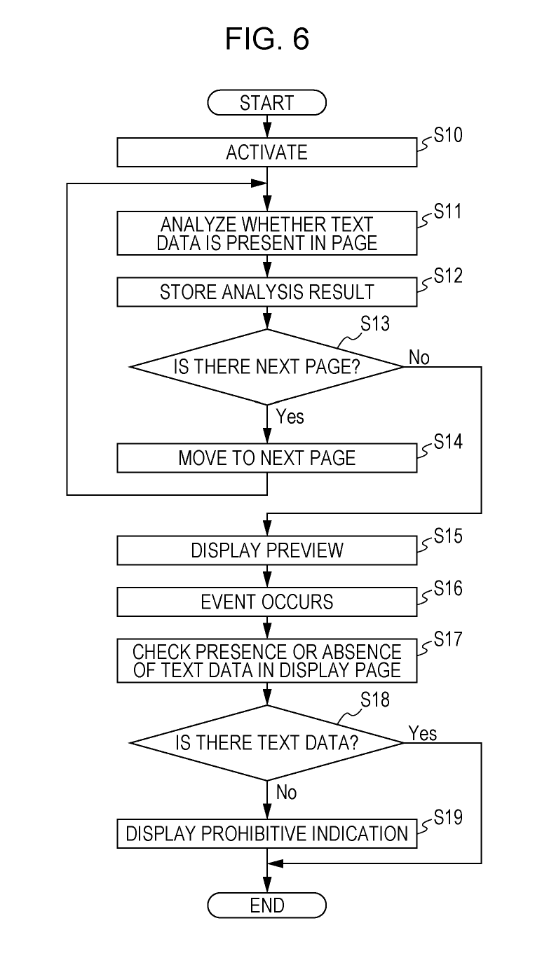

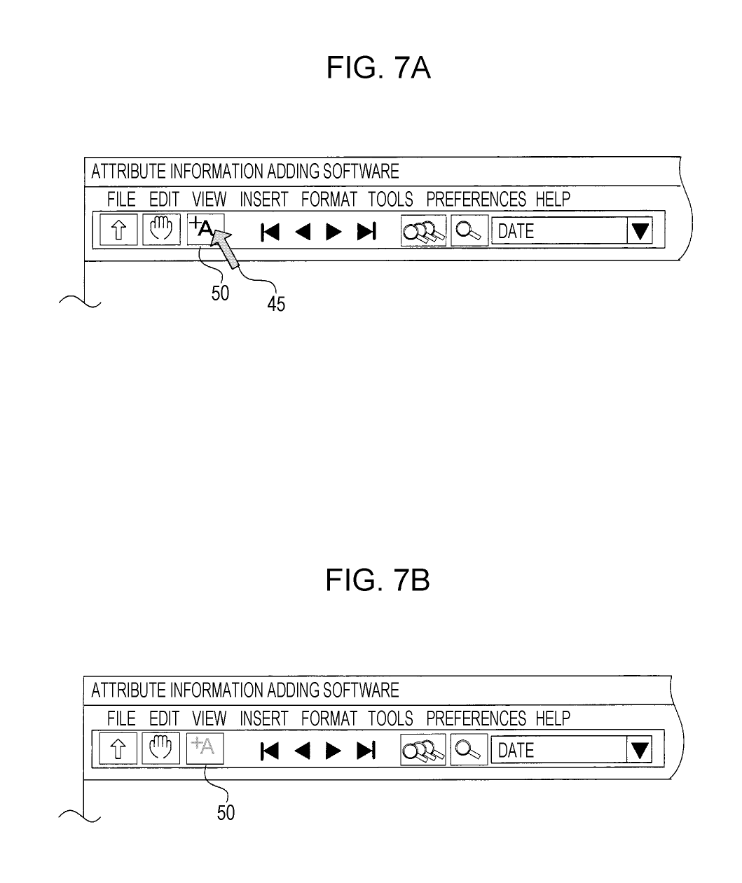

Next, an operation of the document processing apparatus 10 for determining whether the text data is included in the document data is described with reference to FIG. 6, FIG. 7A, and FIG. 7B.

First, when the attribute information adding program 30 is activated (Step S10), the text presence/absence information acquiring part 23 analyzes whether text data is included in selected document data and text selection is enabled (Step S11). An analysis result is stored as the text presence/absence information 32 in the storage device 19 (Step S12).

When a next page is present (Yes in Step S13), the page moves to the next page (Step S14) and analysis is made on whether the text data is included in the next page and the text selection is enabled (Step S11). An analysis result is stored as the text presence/absence information 32 in the storage device 19 (Step S12).

That is, when the document data has plural pages, pieces of information on the presence or absence of the text data in all the pages are acquired and stored as the text presence/absence information 32 in the storage device 19. The attribute information adding part 24 adds the pieces of information on the presence or absence of the text data in all the pages to the document data as the attribute information.

When the pieces of information on the presence or absence of the text data in all the pages are acquired and stored in the storage device 19, a preview image of the document data is displayed on the view screen 47 (Step S15). At this time, the text presence/absence information 32 in the display page is acquired from the storage device 19 (Step S16) to check the presence or absence of the text data in the display page (Step S17).

When the text data is included in the document data in the display page (Yes in Step S18), transition is made to the text selection mode in such a manner that the text selection image 50 is clicked by moving the cursor 45 onto the text selection image 50 as illustrated in FIG. 7A.

That is, when the text data is included in the display page that is displayed on the view screen 47, the user is allowed to input a character string to be added as the attribute information by specifying the range in the document data displayed on the view screen 47, copying the character string, and pasting the character string in the entry field 49 of the setting screen 48. Alternatively, the user is allowed to manually input the character string directly in the entry field 49.

When the text data is not included in the display page (No in Step S18), the display of the text selection image 50 is changed and a prohibitive indication that the text selection is disabled is displayed as illustrated in FIG. 7B (Step S19). Specifically, control is performed so as to disable the operation for the text selection image 50 by, for example, graying out (dimming out) the text selection image 50.

That is, when the display page is switched, the text presence/absence information 32 in the display page is acquired from the storage device 19. When the text data is not present, the prohibitive indication is displayed by graying out the text selection image 50, thereby prohibiting depression of the text selection image 50.

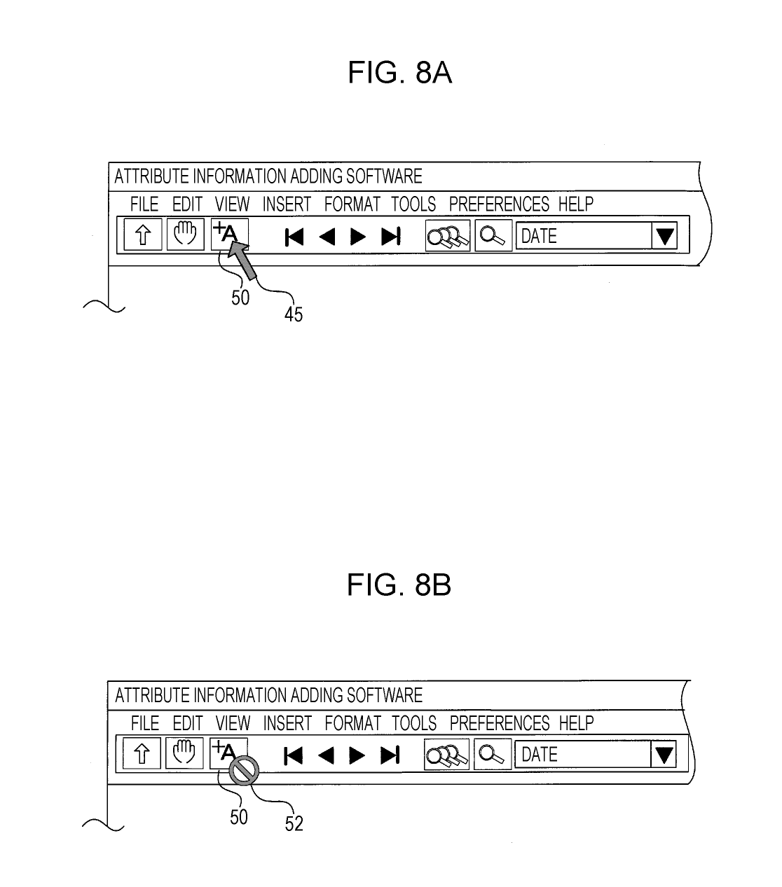

Next, modified examples of this exemplary embodiment are described with reference to FIG. 8A to FIG. 12.

### Modified Example 1

FIG. 8A illustrates an example of the display screen of the document processing apparatus 10 when the text data is included in the document data. FIG. 8B illustrates an example of the display screen of the document processing apparatus 10 when the text data is not included in the document data.

In this modified example, when the cursor 45 is moved onto the text selection image 50, the text presence/absence information 32 in the display page is acquired from the storage device 19.

When the text data is included in the display page, switching is made to the text selection mode in such a manner that the text selection image 50 is clicked by moving the cursor 45 onto the text selection image 50 as illustrated in FIG. 8A. When the text data is not included in the display page, control is performed so as to prohibit depression of the text selection image 50 by changing the shape of the cursor 45 into a prohibition mark 52 (prohibitive indication) when the cursor 45 is moved onto the text selection image 50 as illustrated in FIG. 8B.

### Modified Example 2

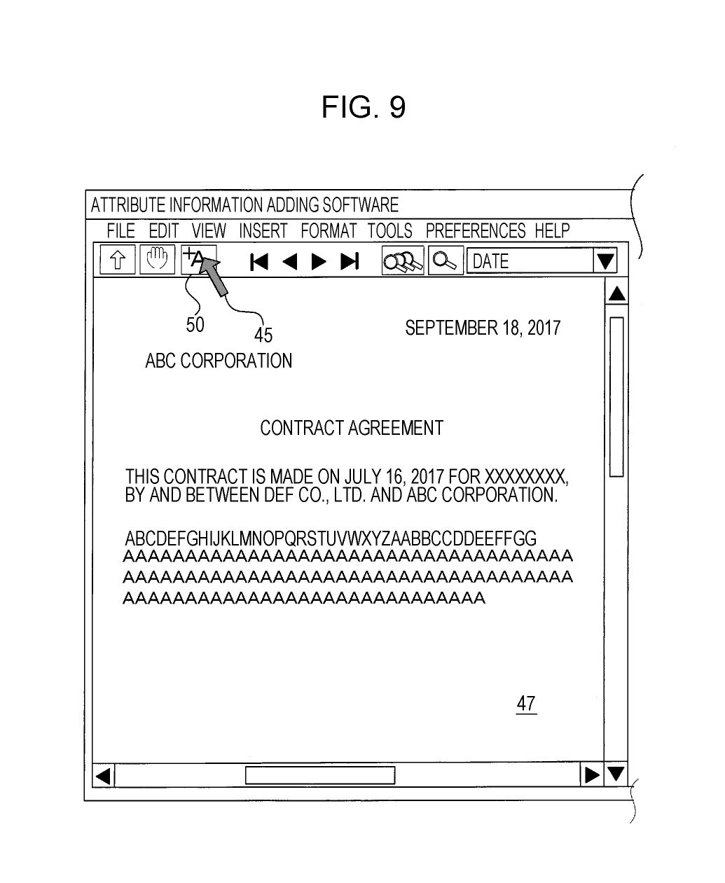

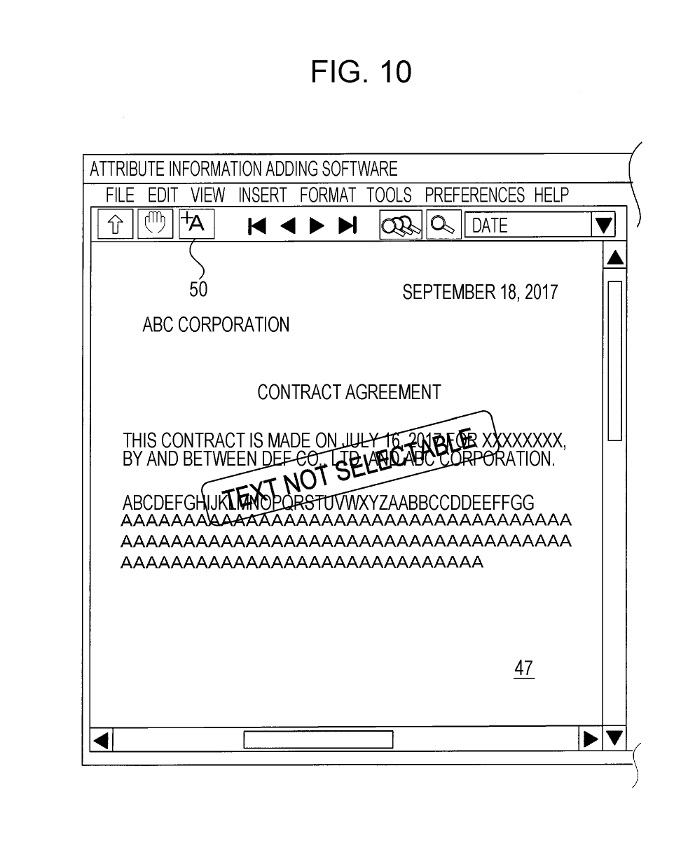

FIG. 9 illustrates an example of the display screen of the document processing apparatus 10 for transition to the text selection mode. FIG. 10 illustrates an example of the display screen of the document processing apparatus 10 when the text data is not included in the display page.

In this modified example, when transition is made to the text selection mode in such a manner that the text selection image 50 is clicked by moving the cursor 45 onto the text selection image 50 as illustrated in FIG. 9, the text presence/absence information acquiring part 23 acquires the text presence/absence information 32 in the display page from the storage device 19.

When the text data is not included in the display page, watermark characters that read “TEXT NOT SELECTABLE” are displayed on the view screen 47 as the prohibitive indication while being superposed on the preview image of the document data as illustrated in FIG. 10. By displaying the prohibitive indication at the timing of transition to the text selection mode, the prohibitive indication does not hinder the viewing of the preview image.

Specifically, the storage device 19 stores image data to be used as the prohibitive indication and its mask image. The display control part 26 combines the preview image and the mask image by obtaining a logical product of both images and obtains a logical sum of the combined image and the image data to be used as the prohibitive indication, thereby performing control so as to display the watermark characters as the prohibitive indication while the watermark characters are superposed on the preview image of the document data.

### Modified Example 3

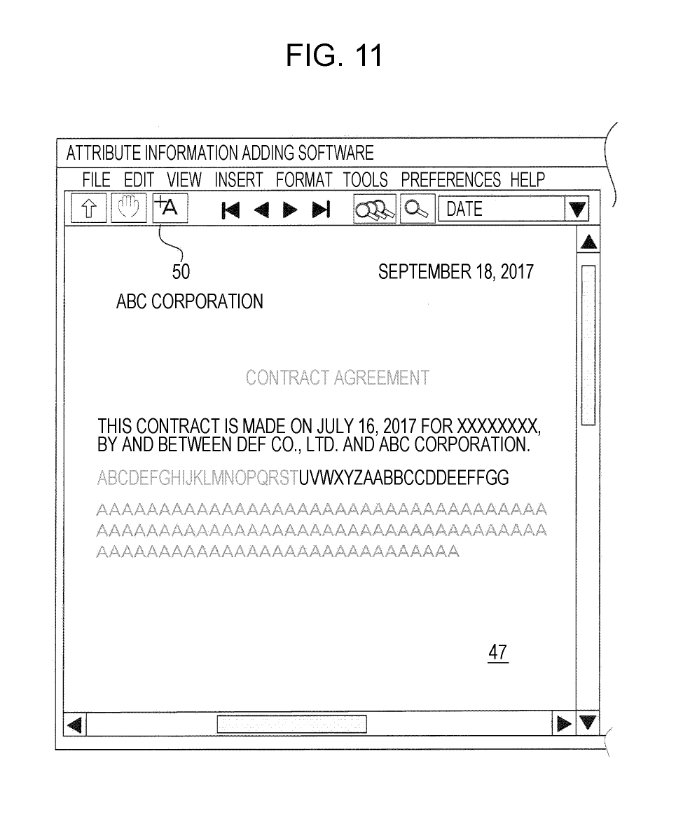

FIG. 11 illustrates an example of the display screen of the document processing apparatus 10 when the text data is included in a partial area of the document data.

In this modified example, when transition is made to the text selection mode in such a manner that the text selection image 50 is clicked by moving the cursor 45 onto the text selection image 50 as illustrated in FIG. 11, the text presence/absence information acquiring part 23 acquires the text presence/absence information 32 in the display page from the storage device 19.

When the text data is included in a partial area of the display page, the area where the text data is included and the text selection is enabled and the area where the text data is not included and the text selection is disabled due to image data or the like are displayed in a distinguishable manner by, for example, changing the color of the image data that is not the text data in the preview image displayed on the view screen 47 as illustrated in FIG. 11. Specifically, the areas are displayed in a distinguishable manner based on, for example, color density in such a manner that the area where the text selection is disabled is grayed out and the area where the text selection is enabled is colored darker than the area where the text selection is disabled. The area where the text selection is enabled and the area where the text selection is disabled may be displayed in a distinguishable manner by using different colors. The area where the text selection is enabled and the area where the text selection is disabled may be displayed in a distinguishable manner by using different fonts. The area where the text selection is enabled and the area where the text selection is disabled may be displayed in a distinguishable manner by using character strings having different sizes. The area where the text selection is enabled may be displayed in a distinguishable manner by enclosing the area in a box.

### Modified Example 4

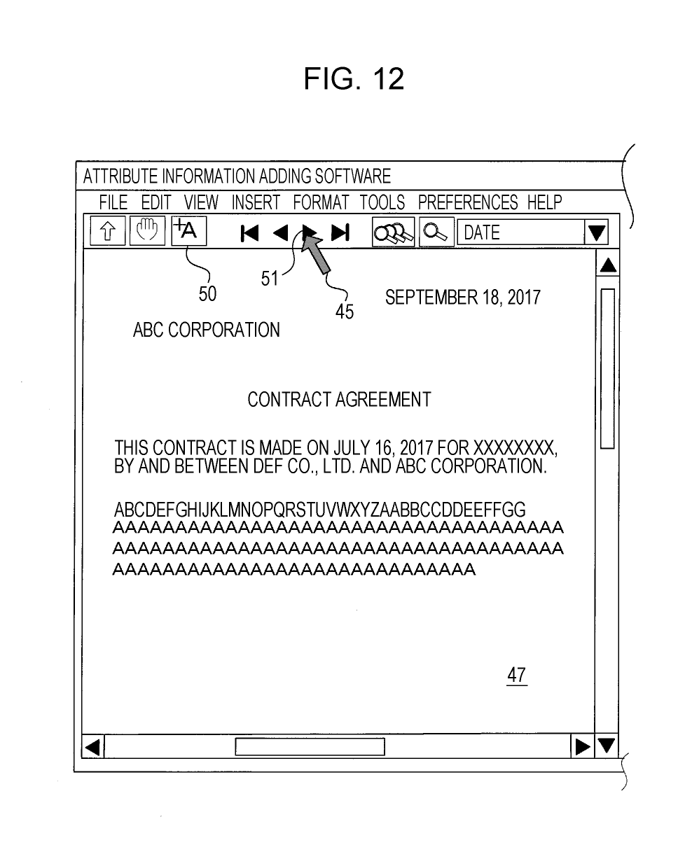

FIG. 12 illustrates an example of the display screen for description of a timing when the text presence/absence information acquiring part 23 acquires the text presence/absence information 32 stored in the storage device 19.

In this modified example, when the page is switched in such a manner that a display page switching image 51 is clicked by moving the cursor 45 onto the display page switching image 51 as illustrated in FIG. 12, the text presence/absence information 32 in the display page is acquired from the storage device 19. When the text data is not included in the display page, control is performed so as to display the prohibitive indication as illustrated in FIG. 10, FIG. 11, or the like.

The exemplary embodiment of the present invention described above is applied to the document management software but is not limited thereto. The exemplary embodiment of the present invention is similarly applicable to any software configurated to edit the document data or the like.

For example, the exemplary embodiment of the present invention is similarly applicable not only to the software for editing the document data on a personal computer but also to software for editing the document data on a portable information terminal apparatus such as a smartphone or a tablet terminal apparatus.

In the exemplary embodiment, programs to be executed by an information processing apparatus may be provided while being recorded in a computer readable recording medium such as a magnetic recording medium (magnetic tape, magnetic disk (HDD or flexible disk (FD)), or the like), an optical recording medium (optical disk (compact disk (CD) or digital versatile disk (DVD)) or the like), a magneto-optical recording medium, or a semiconductor memory (flash ROM or the like). Those programs may be downloaded via a network such as the Internet.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document processing apparatus, comprising:
an execution unit that executes text selection processing for selecting text data from an electronic document; and
a display controller that performs, when the text data is not included in the electronic document, control so as to display an indication that execution of the text selection processing is disabled before a user attempts to execute the text selection processing.

2. The document processing apparatus according to claim 1, wherein, when the text data is not included in the electronic document, the display controller performs control so as to display an indication that an operation image for transition to the text selection processing is not selectable.

3. The document processing apparatus according to claim 2, wherein, when the text data is not included in the electronic document and when a cursor is moved onto the operation image for transition to a state in which the text selection processing is enabled, the display controller performs the control so as to display the indication that the execution of the text selection processing is disabled.

4. The document processing apparatus according to claim 1, wherein, when the text data is not included in the electronic document, the display controller performs control so as to display information indicating that the execution of the text selection processing is disabled while the information is superposed on an image of the electronic document.

5. The document processing apparatus according to claim 4, wherein, when transition is made to a state in which the text selection processing is enabled, the display controller performs the control so as to display the information indicating that the execution of the text selection processing is disabled while the information is superposed on the image of the electronic document.

6. The document processing apparatus according to claim 1, wherein, when the text data is included in a partial area of the electronic document, the display controller performs control so as to display, in a distinguishable manner, the area where the text data is included and an area where the text data is not included.

7. The document processing apparatus according to claim 6, wherein, when transition is made to a state in which the text selection processing is enabled, the display controller performs the control so as to display, in a distinguishable manner, the area where the text data is included and the area where the text data is not included.

8. The document processing apparatus according to claim 1, wherein, when a page of the electronic document to be displayed is switched and when the text data is not included in the page, the display controller performs the control so as to display the indication that the execution of the text selection processing is disabled.

9. The document processing apparatus according to claim 1, further comprising:
an acquisition unit that acquires presence/absence information related to presence or absence of the text data in each page when the electronic document is displayed; and
a memory that stores the presence/absence information acquired by the acquisition unit.

10. The document processing apparatus according to claim 9, wherein the acquisition unit collectively acquires pieces of the presence/absence information in all pages.

11. The document processing apparatus according to claim 9, wherein the acquisition unit acquires the presence/absence information every time a page is switched.

12. The document processing apparatus according to claim 9, further comprising an addition unit that adds the presence/absence information acquired by the acquisition unit to the electronic document as attribute information.

13. The document processing apparatus according to claim 1,
wherein presence/absence information related to presence or absence of the text data in each page is added to the electronic document as attribute information, and
wherein the display controller performs control so as to display whether the text data is included in each page of the electronic document by referring to the presence/absence information.

14. A non-transitory computer readable medium storing a program causing a computer to execute a process comprising:
executing text selection processing for selecting text data from an electronic document; and
performing, when the text data is not included in the electronic document, control so as to display an indication that execution of the text selection processing is disabled before a user attempts to execute the text selection processing.

15. A document processing apparatus, comprising:
execution means for executing text selection processing for selecting text data from an electronic document; and
display control means for performing, when the text data is not included in the electronic document, control so as to display an indication that execution of the text selection processing is disabled before a user attempts to execute the text selection processing.
